(19) United States
(12) Patent Application Publication
(10) Pub. No.: US 2007/0001440 A1
(43) Pub. Date: Jan. 4, 2007

(54) Gas generator with integrated electrical plug

(75) Inventors: Gunther Schmid, Rothis (AT); Manfred Mahr, Rothis (AT)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Automotive GmbH

(21) Appl. No.: 11/453,570

(22) Filed: Jun. 15, 2006

(30) Foreign Application Priority Data
Jun. 15, 2005 (DE) 102005027539.7
Dec. 24, 2005 (DE) 102005062329.8

(51) Int. Cl. B60R 21/26; B60R 22/46

(52) U.S. Cl. 280/741; 280/736; 280/806

(57) ABSTRACT

A gas generator has a housing extending along an axis and having a front end and a rear end, a propellant charge in the front end of the housing, and an electrically firable igniter in the housing adjacent the charge. An end fitting fitted to the rear end of the housing is formed as a plug. Electrical contacts exposed at the end fitting and extending therethrough are connected to the igniter.

### FIELD OF THE INVENTION

The present invention relates to a gas generator. More particularly this invention concerns such a generator used to operate a motor-vehicle air bag or seat belt.

### BACKGROUND OF THE INVENTION

A standard gas generator comprises an igniter unit, a propellant charge, and a housing. The igniter is electrically fired and has contacts that are connected at a rear end of the gas generator to a controller that operates the device. Such units are typically used in safety devices, and serve for example to inflate an air bag or lock a seat-belt retractor in case of a collision.

The electrical connection can be of the lead-wire or pin type. With the wire connection, a pair of insulated wires, which may be integrated into a cable, extend out of the rear end of the generator and are connected to respective terminals nearby.

As described in German 102 02 920 of Pfeifer, the pin-type connection has solid contacts, typically pins, fixed in the end of the generator and matable with terminals of the control unit. Such a pin mount complies with the so-called VDA 11 mm standard and has a coded end so that the generator contacts are effectively polarized. This system has quite a few parts and requires special construction of the gas generator.

### OBJECTS OF THE INVENTION

It is therefore an object of the present invention to provide an improved gas generator with integrated electrical plug.

Another object is the provision of such an improved gas generator with integrated electrical plug that overcomes the above-given disadvantages, in particular that can be made very small, in a miniature model.

### SUMMARY OF THE INVENTION

A gas generator has according to the invention a housing extending along an axis and having a front end and a rear end, a propellant charge in the front end of the housing, and an electrically firable igniter in the housing adjacent the charge. An end fitting fitted to the rear end of the housing is formed as a plug. Electrical contacts exposed at the end fitting and extending therethrough are connected to the igniter.

In this way the end of the gas generator can be plugged directly into the controller or a connector thereof. This greatly simplifies the installation and construction of the gas generator, and in fact allows it to be made very small. The number of parts is significantly reduced and the integrated assembly is very rugged.

The end fitting according to the invention forms an axial extension of the housing. Normally they are of identical cross-sectional shape.

The gas generator in accordance with the invention can also have a coding, be formed with a snap connection for a plug, and/or with a shorting bridge (see above-mentioned DE '920) engageable with the contacts.

At least an outer portion of the fitting is of plastic, typically Duroplast, known for its strength, heat- and cold-resistance, and high dielectric properties.

The gas generator further has according to the invention formations forming a snap connection between the fitting and the housing. Alternately or in addition the end fitting is force-fitted to the housing and/or it is molded to the housing.

The fitting further has a radially projecting rim axially buttable against a mounting formation. Normally the outer diameter or shape of the rim corresponds exactly to that of the part of the seat-belt retractor or air-bag mount it fits into, so that when the generator is installed it merely leaves its rear plug end exposed.

The fitting also has a collar fitted to the housing and spreadable on firing of the igniter to tightly grip and block against the housing.

### BRIEF DESCRIPTION OF THE DRAWING

The above and other objects, features, and advantages will become more readily apparent from the following description, reference being made to the accompanying drawing in which:

FIG. is a gas generator according to the invention partly in longitudinal/axial section;

FIG. 2 is a view of just the igniter of the generator;

FIG. 3 is an axial section through the rear end of the igniter with its connector;

FIG. 4 is an end view taken in the direction of arrow IV of FIG. 3; and

FIG. 5 is a side view of the rear end of the structure of FIG. 3.

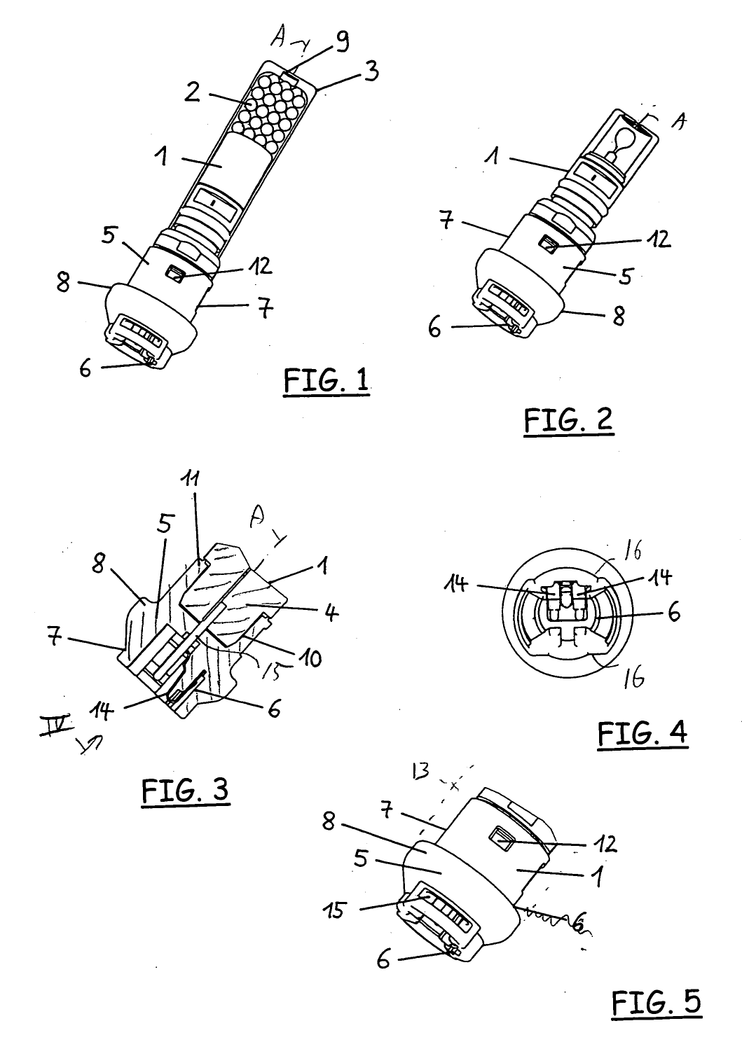

### SPECIFIC DESCRIPTION

As seen in FIG. 1 a miniature or micro-model gas generator according to the invention has a cylindrically tubular housing 3 centered on an axis A and holding a propellant charge 2 that can be set off by a primer or igniter 1 to generate a large volume of gas that can be expelled axially forward through a weakening or fenestration 9 in the end of the casing 3.

Contact pins 15 (FIG. 3) project from the igniter 11 into a plug fitting 5 seated on a reduced-diameter extension 10 of a rear end 4 of the igniter 1. This fitting 5 is made of a durable and nonconductive plastic and is formed with seats 6 for an appropriate connector of a control unit. In addition a shorting bridge 14 is mounted in the connecter 5 to ensure that the two contact pins 15 are connected electrically together until the device is hooked up, thereby preventing accidental ignition from static electricity or the like.

The fitting 5 is therefore formed with an axially forwardly extending cylindrical collar 11 that engages snugly around the extension 10 of the igniter end 4. A snap fitting 12 can lock the two parts together, although this connection could also be made by force fit or even by molding the fitting 5 directly on the igniter 1. In addition the fitting 5 also has a radially outwardly projecting ridge 8 that allows it to be fitted to a cylindrical socket shown schematically at dashed lines 13 forming part of an air-bag or seat-belt assembly. A rear end 7 of the fitting 5 is formed as a cylindrical collar for direct plugging into a socket of an appropriate unillustrated control unit. The fitting 5 has coding formations 16 and is provided with a latch formation 15 for snapping to a plug or socket.

We claim:

1. A gas generator comprising:
a housing extending along an axis and having a front end and a rear end;
a propellant charge in the front end of the housing;
an electrically firable igniter in the housing adjacent the charge;
an end fitting fitted to the rear end of the housing and formed as a plug; and
electrical contacts exposed at the end fitting, extending therethrough, and connected to the igniter.

2. The gas generator defined in claim 1 wherein the end fitting forming an axial extension of the housing.

3. The gas generator defined in claim 1 wherein the end fitting has a coding.

4. The gas generator defined in claim 1 wherein the end fitting is formed with a snap connection for a plug.

5. The gas generator defined in claim 1 wherein the end fitting is provided with a shorting bridge engageable with the contacts.

6. The gas generator defined in claim 1 wherein at least an outer portion of the fitting is of plastic.

7. The gas generator defined in claim 1 wherein the plastic is duroplast.

8. The gas generator defined in claim 1 further comprising
formations forming a snap connection between the fitting and the housing.

9. The gas generator defined in claim 1 wherein the end fitting is force-fitted to the housing.

10. The gas generator defined in claim 1 wherein the end fitting is molded to the housing.

11. The gas generator defined in claim 1 wherein the fitting has a radially projecting rim axially buttable against a mounting formation.

12. The gas generator defined in claim 1 wherein the fitting has a collar fitted to the housing and spreadable on firing of the igniter to tightly grip and block against the housing.
